(19) United States
(12) Patent Application Publication
(10) Pub. No.: US 2023/0122161 A1
(43) Pub. Date: Apr. 20, 2023

(54) SELF-LOCKING RETAINER PIN

(71) Applicant: RB Distribution, Inc., Colmar, PA (US)

(72) Inventors: Thomas Allan REIFF, Portage, MI (US); Jonathan Newlin PETRINA, Glenside, PA (US)

(73) Assignee: RB Distribution, Inc., Colmar, PA (US)

(21) Appl. No.: 17/502,453

(22) Filed: Oct. 15, 2021

(51) Int. Cl. F16B 39/04

(52) U.S. Cl. CPC F16B 39/04

(57) ABSTRACT

A resilient self-locking retainer pin comprising a horizontal member with a leading end that fits the through hole of a related part and a trailing end that are spaced to define a part capture area between them. The spaced apart ends are opposed resilient members that spaced apart to abut and secure the related part.

### FIELD OF INVENTION

The present invention relates generally to devices, such as cotter pins that are used to retain or secure various components, such as a nut on a threaded shaft, in position. More particularly the present invention relates to a self-locking retainer pin. Most particularly, the present invention relates to a self-locking retainer pin that is preferably pre-sized to the application to define a capture area for the part that is to be retained.

### BACKGROUND

Retainers, such as pins, are commonly used to secure the position of a movable body relative to another body. In the simplest form of, a cotter pin, the pin has an elongated wire that is folded back on itself to create a loop or semi-circular base with two parallel tines extending from the base. The base is dimensioned to be larger in diameter than the central pin and will abut a through hole in a related component. To secure a cotter pin in place, the tines are bent outward to abut the opposite end of the through hole from the base. The diameter and length of the cotter pin varies according to the application.

Know retainer pins have at least two problems. One, the security of the pin depends on the degree to which the installer bends the tines outwardly. Two, the outwardly bent tines can catch on other components or collect debris.

Applicant has recognized that there is a need for a more secure retainer as well as one that is more easily applied.

### SUMMARY

The disclosed present retainer pin eliminates the need for the traditional separation of the tines to secure the retainer in place and the provision of a defined capture area improves security among the components.

### BRIEF DESCRIPTION OF THE DRAWINGS

FIG. 1 is a perspective view of the self-locking retainer pin;

FIG. 2 is a side elevation of the self-locking retainer pin;

FIG. 3 is a section through the line 3-3 to illustrate the shape of the retainer body;

FIG. 4 is a side view illustrating a capture area for a self-locking retainer pin; and,

FIG. 5 illustrates the installed condition of the self-locking retainer pin in use on a castellated nut.

### DETAILED DESCRIPTION OF THE PREFERRED EMBODIMENT

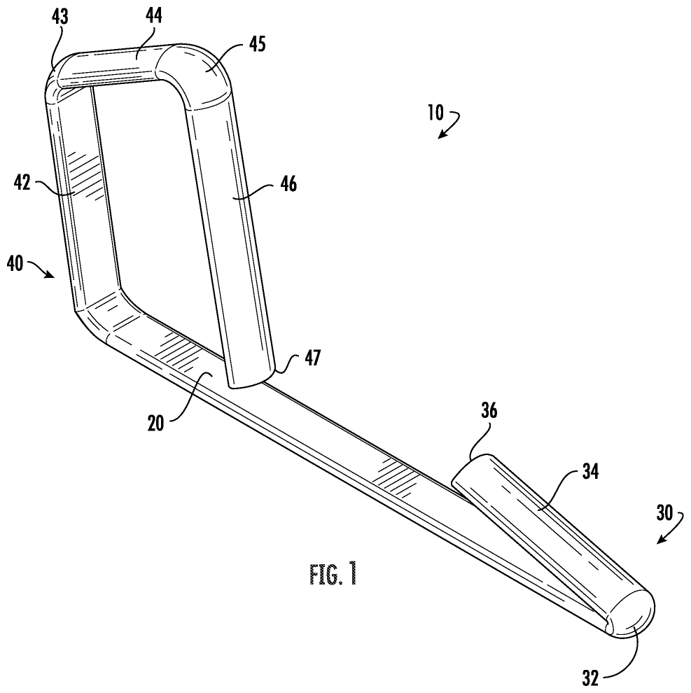

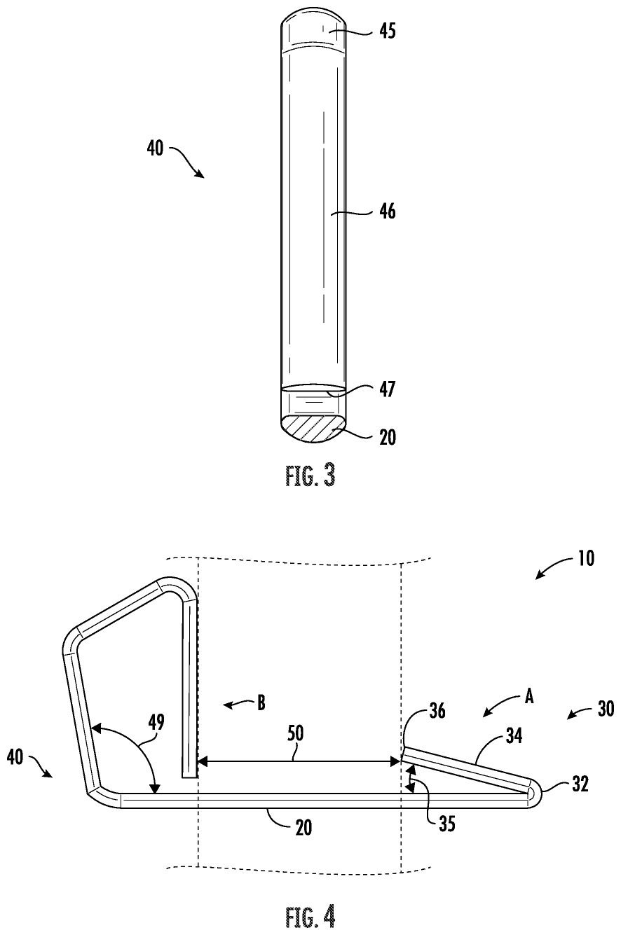

Referring now to the drawings and to FIG. 1 in particular, the retainer pin 10 is preferably a unitary construction formed from a single piece of a resilient material, such as carbon steel or spring steel. It is further preferred to use a Zinc Cr3 finish to improve corrosion resistance. The retainer pin 10, as shown in FIG. 3, is preferably semi-circular.

The retainer pin 10 is preferable formed with an elongated central portion 20, a lead end 30 and trailing end 40. The lead end 30 has an elbow bend 32 that directs the extension 34 back over the central portion 20 in the direction of the trailing end 40. The trailing end 40 has a loop that is formed over the central portion 20 by elbow 22, generally vertical rear portion 42, elbow 43, generally horizontal portion 44, elbow 45 and generally vertical forward portion 46. The end 47 of the generally vertical portion is a free or cantilevered end 47 that is separated from central portion 20. This construction permits the loop 40 to be flexed.

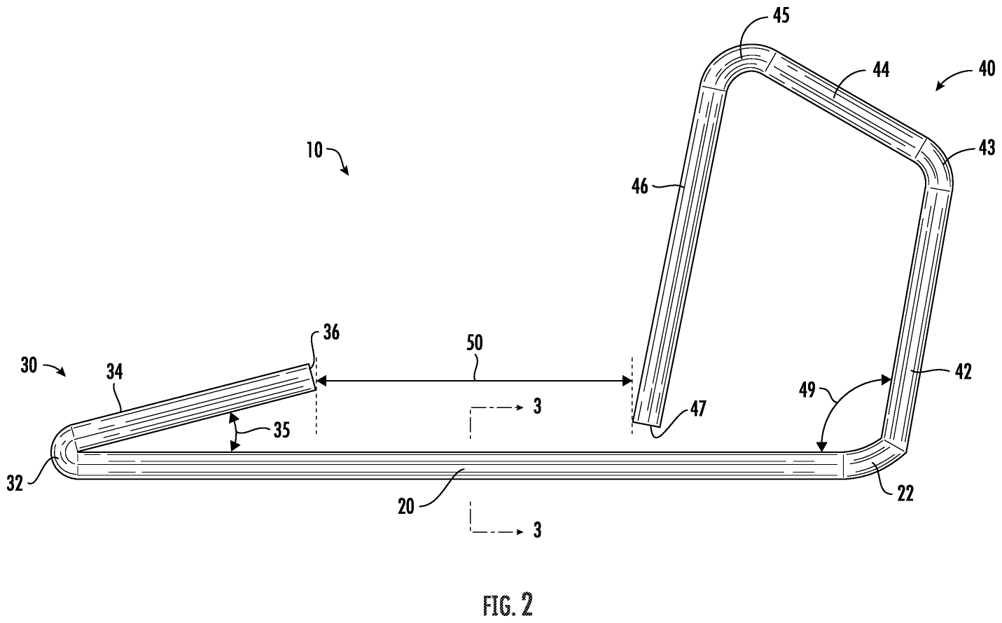

FIG. 2, a side elevation view of the retainer pin 10, shows that the extension 34 is at an acute angle 35 with respect to the central portion 20 to form a triangular area between extension 34 and central portion 20. In a preferred embodiment, the extension 34 forms an acute angle 35 of 17 degrees with the central portion 20. Due to the use of a resilient material, the extension 34 is compressed toward the central portion when the elbow 32 enters a through hole formed in a selected component of an assembly that is to be secured. After the extension 34 clears the through hole, the extension 34 rebounds so that the end 36 comes into abutment with a component

A handle like loop is formed at the trailing end 40 so it convenient to grip the retaining pin 10 and direct the leading end 30 into a through hole. The forward portion 46 of trailing end 40 opposes the free end 36 and they form an object capture space 50 between them. Because the forward portion 46 is also resilient and the free end 47 is unattached, portion 46 can be urged or compressed toward an imaginary perpendicular to the central portion. This compressibility provides additional space for the extension 34 to clear the through hole. After the extension clears the through hole and the retainer pin is released, the rebound portion 46 rebounds away from the imaginary perpendicular and the component is retained in the capture space 50. In a preferred embodiment, the generally vertical rear portion 42 forms obtuse angle 49 of approximately 100 degrees with the central portion 20, so that the loop has a rectangular or inverted “U” shape with respect to the elongated portion.

FIG. 3 is a section showing that the resilient material is preferable extruded with a semi-circular shape on the exterior and a flat interior. With reference to FIG. 4, the insertion force A compresses the extension 34 downward while the continued insertion brings the component into contact with the forward portion 46 and urges it rearward to compress both the forward portion 46 and the rear portion 42 until the insertion is completed. Upon completion the retainer pin rebounds toward the initial construction.

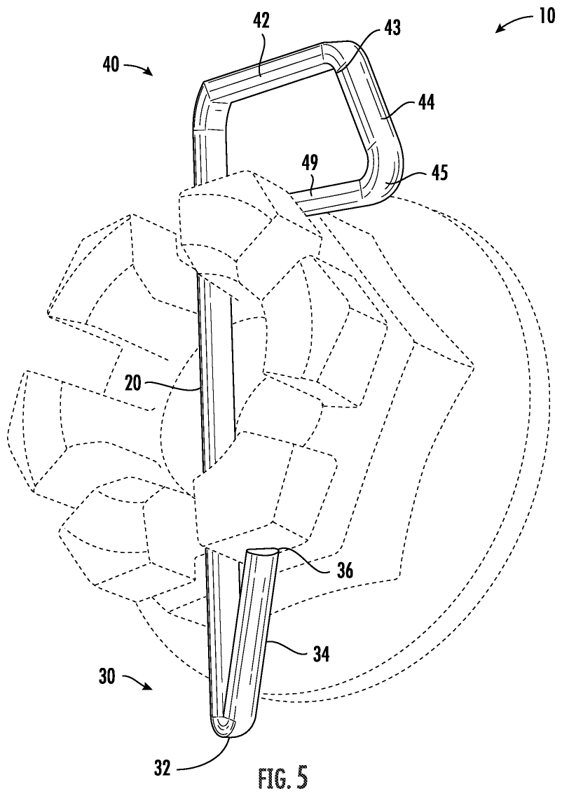

FIG. 5 illustrates the installed condition of the retainer pin 10 used with a castellated nut. The extension 34 is in contact with a facet of the castellated nut and the forward portion 46 is in contact with another facet of the castellated nut, which arranges the facet of the castellated nut in capture space 50.

What is claimed is:

1. A self-locking retainer comprising:
an elongated portion with a lead end and a trailing end;
the lead end is bent over the elongated portion and is angled toward the elongated portions;
the trailing end is looped over the elongated portion with a free end that faces the elongated portion;
wherein the lead end and the trailing end are spaced apart to define an object capture space on the elongated portion.

2. The self-locking retainer of claim 1, wherein the lead end forms an acute angle with the elongated portion.

3. The self-locking retainer of claim 1, wherein the trailing end has generally rectangular configuration.

4. The self-locking retainer of claim 1, wherein the trailing end has a rear portion that is at an obtuse angle with respect to the elongated portion and the lead end is at an acute angle with respect to the elongated portion.

5. The self-locking retainer of claim 4, wherein the loop of the trailing end has a rectangular configuration.

6. A self-locking retainer comprising:
a unitary structure having,
an elongated portion with an angular leading end that extends toward a trailing end that is looped and extends toward the leading end;
wherein the leading end and a forward portion of the trailing end define an object capture space between them on the elongated portion.

7. The self-locking retainer of claim 6, wherein the lead end forms an acute angle with the elongated portion.

8. The self-locking retainer of claim 6, wherein the trailing end has a rear portion that is at an obtuse angle with respect to the elongated portion and the lead end is at an acute angle with respect to the elongated portion.

9. The self-locking retainer of claim 8, wherein the trailing end is looped in a rectangular configuration.

10. The self-locking retainer of claim 6, wherein the trailing end has generally rectangular configuration.

11. The self-locking retainer of claim 7, wherein the trailing end has a rear portion that is at an obtuse angle with respect to the elongated portion.

12. The self-locking retainer of claim 11, wherein the trailing end is looped in a generally rectangular configuration.

13. The self-locking retainer of claim 6, wherein the retainer has a semi-circular exterior and a flat interior.
